(19) United States
(12) Patent Application Publication
(10) Pub. No.: US 2011/0026067 A1
(43) Pub. Date: Feb. 3, 2011

(54) IMAGE FORMING APPARATUS, CONTROL METHOD THEREFOR, AND STORAGE MEDIUM STORING PROGRAM FOR THE SAME

(75) Inventor: Jun Hamaguchi, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/935,562

(22) PCT Filed: Apr. 30, 2009
(86) PCT No.: PCT/JP2009/058795

§ 371 Date: Sep. 29, 2010

(30) Foreign Application Priority Data
May 13, 2008 (JP) 2008-125934

(51) Int. Cl. G06K 15/00

(52) U.S. Cl. 358/1.14

(57) ABSTRACT

An image forming apparatus capable of being used for a longest possible time period without the need for a user to determine the necessity of part replacement. In a case that a conveyance roller or other part whose consumption degree exceeds a prescribed value is used for a job set by the user, an MFP displays to the user candidates for alternative process using an alternative path in which the conveyance roller or other part is not used and a candidate for alternative process to perform a low-speed process (S702 to S704). The candidates for alternative paths are selected based on weight information set in such a manner that alternative paths are selected in an ascending order of jam occurrence rate acquired from a monitoring server.

### TECHNICAL FIELD

The present invention relates to an image forming apparatus, a control method therefor, and a storage medium storing a program for executing the control method. More particularly, this invention relates to a technique to provide a countermeasure against a recording sheet jam.

### BACKGROUND ART

There have been known an image forming apparatus such as a copier, a printer, or the like having part counters for counting operation amounts of consumable parts and adapted to carry out an optimum image formation based on the counted operation amounts of consumable parts.

For example, some known image forming apparatus is designed to refer to part counters to confirm operation amounts of consumable parts before execution of a job and preferentially use a consumable part having a lowest use frequency among consumable parts associated with an output form desired by a user, to thereby prolong the service life of the entire apparatus (see, PTL (Patent Literature) 1,shown below).

Another technique has been proposed that determines before execution of a job whether or not the job can be completed and, if it is determined that the job cannot be completed, displays an indication to that effect on an operation unit (see, PTL (Patent Literature) 2, shown below).

An image forming apparatus is also known that notifies a monitoring server of not only part counter information but also information on jam, alarm, failure, etc. The monitoring server stores contents of notifications, determines an operation state of the image forming apparatus based on the stored contents, and takes necessary steps when a failure occurs in the apparatus.

A system is also proposed, in which consumption degrees of consumable parts of an image forming apparatus are determined by the image forming apparatus per se and the determined consumption degrees are displayed on a display unit or notified to a monitoring server (see, PTL (Patent Literature) 3, shown below).

The techniques disclosed in PTLs 1 to 3 do no cause a substantial problem in a circumstance where consumable parts are periodically replaced by a service personnel or the like. To reduce maintenance costs, however, it is preferable that the maintenance be easily performed by a user without the need of periodical maintenance by a service personnel or the like.

Nevertheless, in a case that maintenance is carried out by a user, the user does not always care about consumption degrees of consumable parts and is liable to overlook the necessity for consumed part replacement. When a consumed part to be replaced is kept used without replacement, there is a fear that a jam and other trouble are frequently caused.

In that case, if a part in trouble is detected and the usage thereof is simply prohibited, the entire apparatus function or some apparatus function cannot be utilized due to the presence of that one part to be replaced. As a result, the user's convenience is greatly impaired.

Further, it is difficult for the user to determine whether or not a consumed part not usable will be used for a job which the user wishes to perform.

### {Citation List}

### {Patent Literature}

{PTL 1} Japanese Laid-open Patent Publication No. 2003-15482

{PTL 2} Japanese Laid-open Patent Publication No. 2001-63188

{PTL 3} Japanese Laid-open Patent Publication No. 2003-316555

### SUMMARY OF INVENTION

### Technical Problem

The present invention provides an image forming apparatus able to eliminate the user's effort to determine the necessity of part replacement and usable over a longest possible time period, and provides a control method for the image forming apparatus and a storage medium storing a program for executing the control method.

### Solution to Problem

Accordingly, an image forming apparatus according to this invention comprises a counting unit adapted to count consumption degrees of conveyance parts in a plurality of conveyance paths along which sheets are conveyed, an acquisition unit adapted to acquire information on occurrence of conveyance failure in each of the plurality of conveyance paths, a determination unit adapted to determine, based on a result of counting by the counting unit, whether or not the consumption degree of a conveyance part in a conveyance path, among the plurality of conveyance paths, used for execution of a job set by an operation on an operation unit exceeds a prescribed value, a selection unit adapted, in a case where the determination unit determines that the consumption degree exceeds the prescribed value, to select a candidate for alternative process for the job based on the information on occurrence of conveyance failure acquired by the acquisition unit, and a presentation unit adapted to present the candidate for alternative process selected by the selection unit.

Accordingly, a control method for an image forming apparatus according to this invention comprises a counting step of counting consumption degrees of conveyance parts in a plurality of conveyance paths along which sheets are conveyed, an acquisition step of acquiring information on occurrence of conveyance failure in each of the plurality of conveyance paths, a determination step of determining, based on a result of counting in the counting step, whether or not the consumption degree of a conveyance part in a conveyance path, among the plurality of conveyance paths, used for execution of a job set by an operation on an operation unit exceeds a prescribed value, a selection step of selecting, in a case where the determination step determines that the consumption degree exceeds the prescribed value, a candidate for alternative process for the job based on the information on occurrence of conveyance failure acquired in the acquisition step, and a presentation step of presenting the candidate for alternative process selected in the selection step.

Accordingly, according to this invention, there is provided a computer-readable storage medium storing a program for causing a computer to execute the control method of this invention.

The features and advantages of the invention will become more apparent from the following detailed description taken in conjunction with the accompanying drawings.

### BRIEF DESCRIPTION OF DRAWINGS

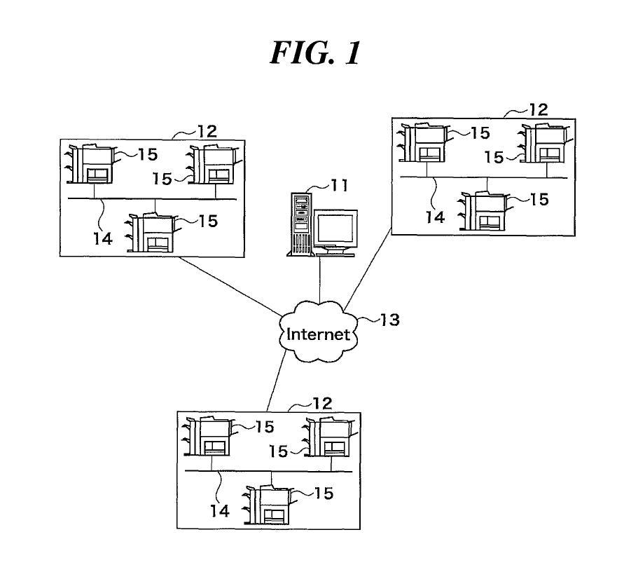

{FIG. 1} A view showing the system construction of an image forming system including image forming apparatuses according to one embodiment of this invention.

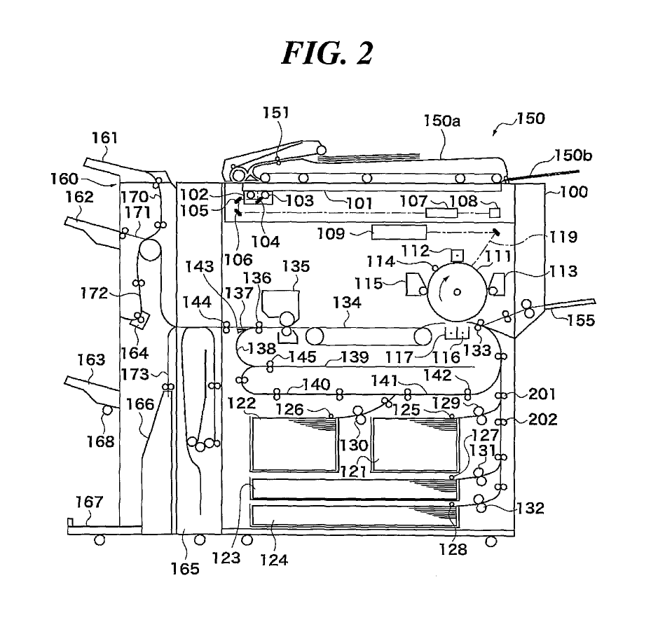

{FIG. 2} A section view showing the hardware construction of MFPs shown in FIG. 1.

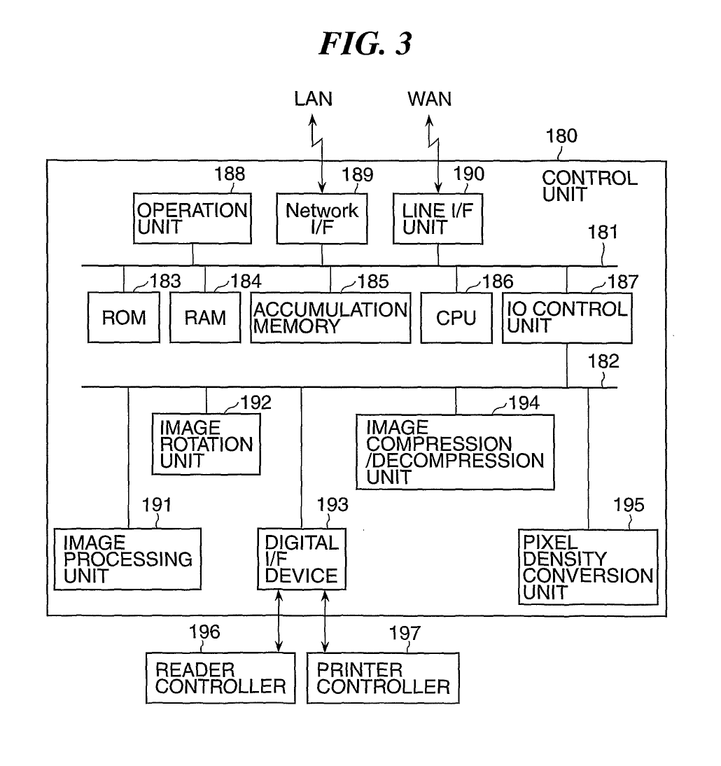

{FIG. 3} A block diagram showing the construction of a control unit of each MFP.

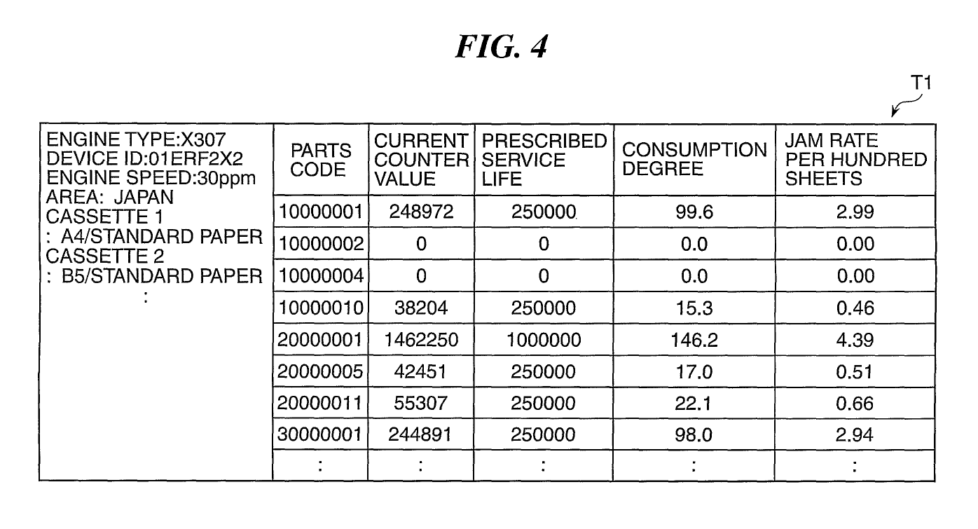

{FIG. 4} A view showing registration data in a parts management table held by the MFP.

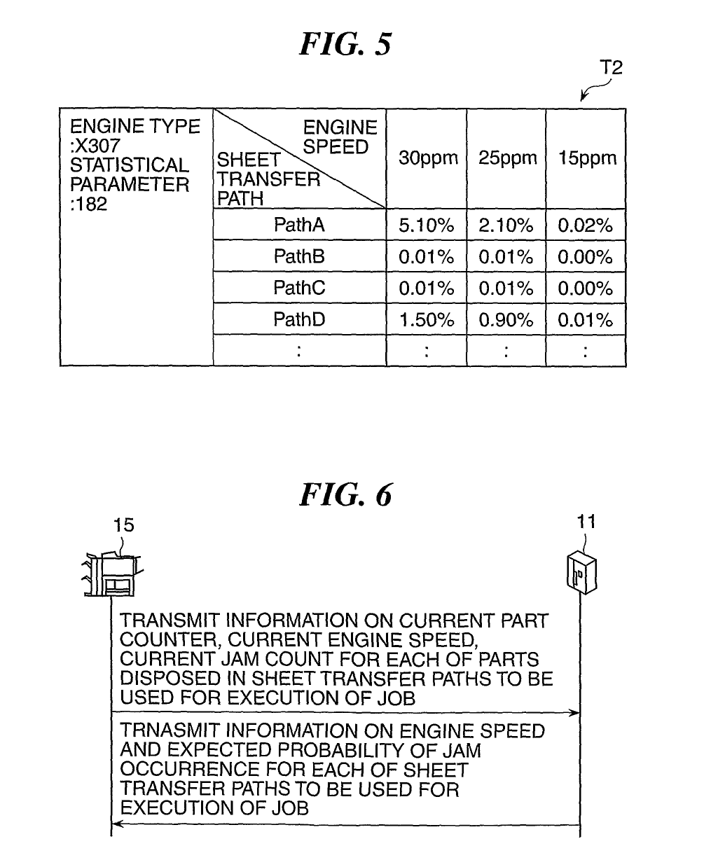

{FIG. 5} A view showing registration data in a jam occurrence rate table held by a monitoring server.

{FIG. 6} A view for explaining transmission and reception of data registered in the parts management table and the jam occurrence rate table between the MFP and the monitoring server.

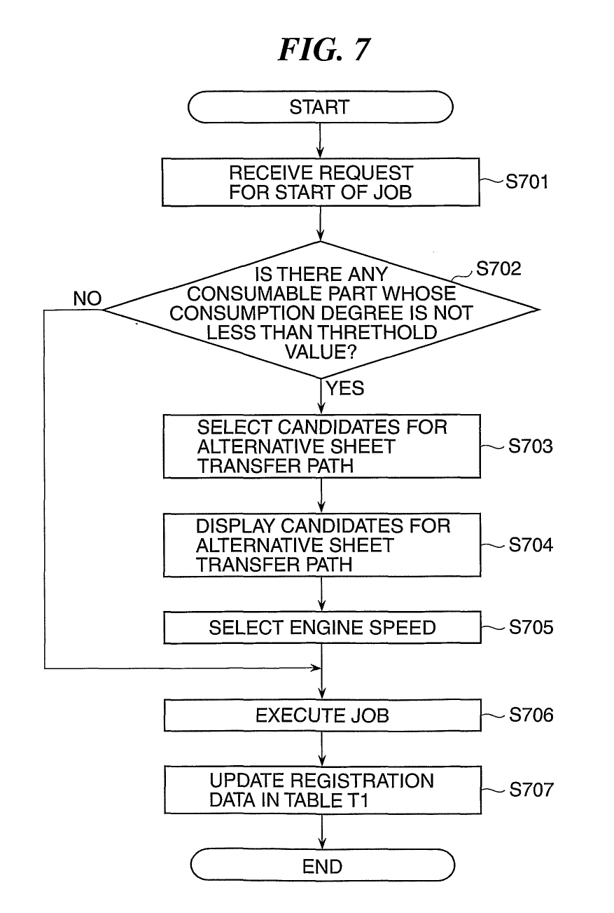

{FIG. 7} A flowchart showing the outline of a job process performed by the MFP.

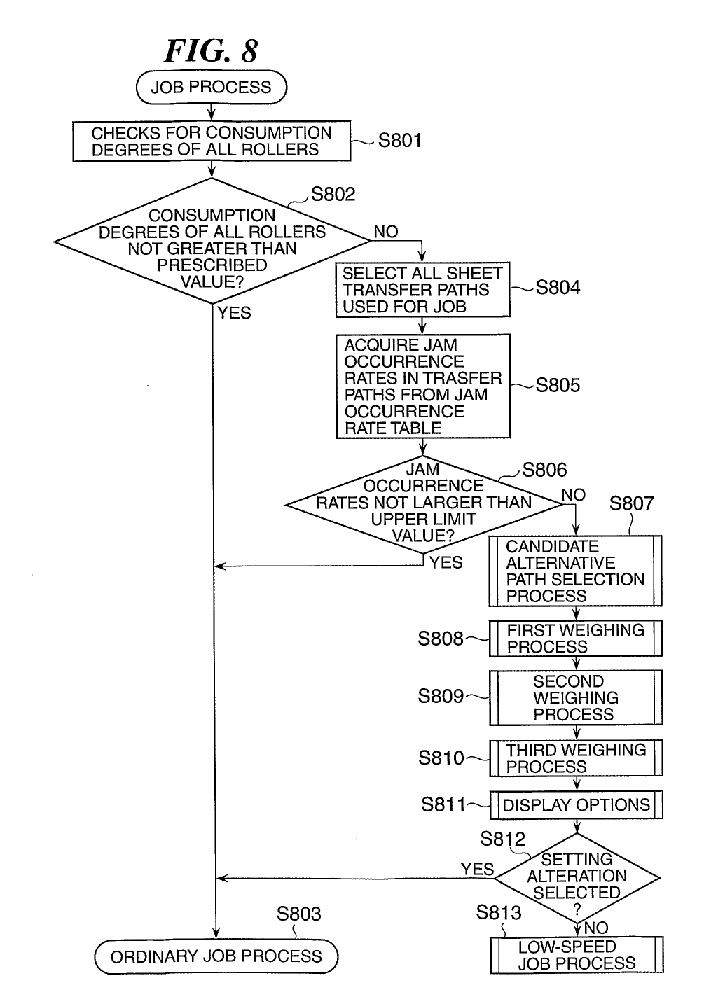

{FIG. 8} A flowchart showing the details of the job process.

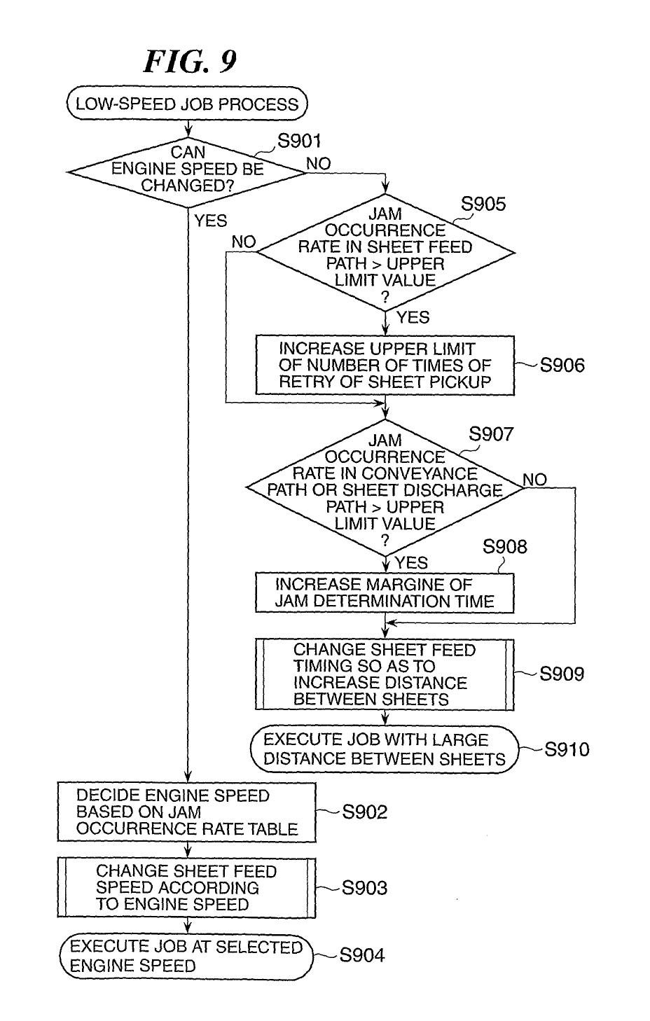

{FIG. 9} A flowchart showing the details of a low-speed job process performed in step S813 in FIG. 8.

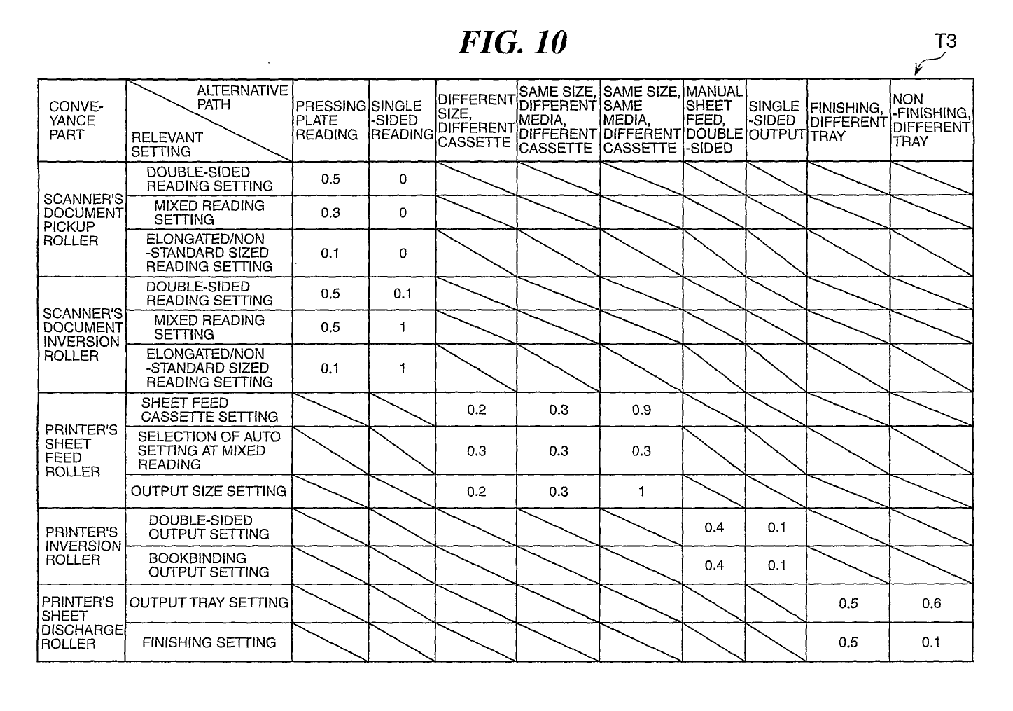

{FIG. 10} A view showing example information in a priority determination table.

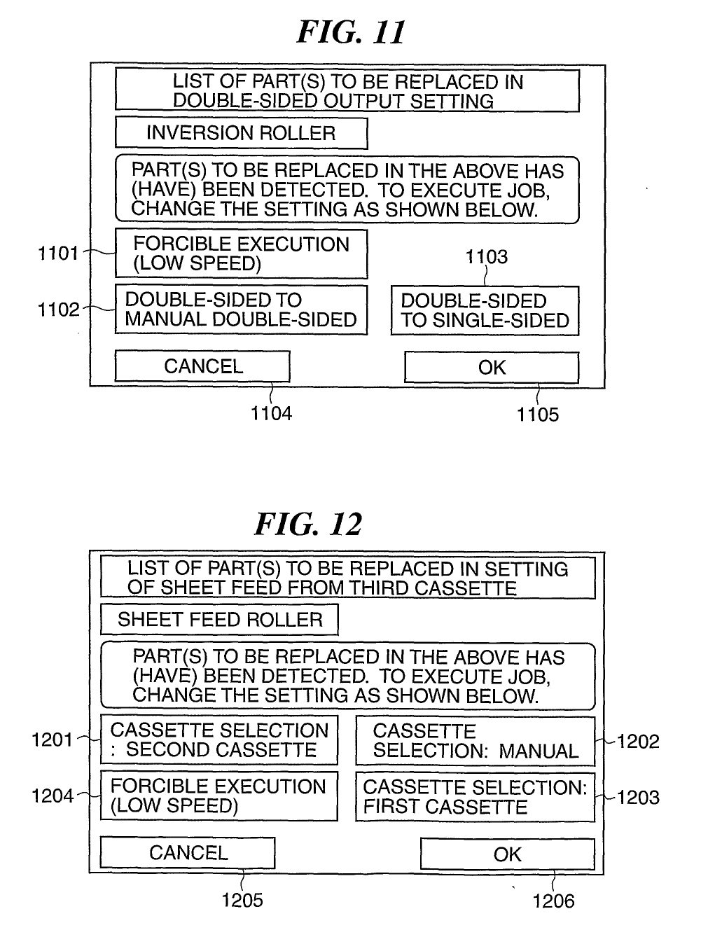

{FIG. 11} A view showing an example display (example presentation) of candidates for an alternative job displayed when a job with double-sided printing specification is set.

{FIG. 12} A view showing an example display (example presentation) of candidates for an alternative job displayed when a job with sheet feed stage specification is set.

### DESCRIPTION OF EMBODIMENT

In the following, a best mode for carrying out this invention will be described with reference to the appended drawings. FIG. 1 shows the system construction of an image forming system including image forming apparatuses according to one embodiment of this invention.

In the image forming system in FIG. 1, monitoring servers (one of which is shown at 11) and intranets 12 are connected to the internet 13. Each of the intranets 12 has a LAN 14 to which a plurality of image forming apparatuses 15 such as MFPs are connected. The monitoring servers 11 are each disposed at a corresponding one of locations. Each monitor server 11 collectively monitors operation states of image forming apparatuses 15 belonging to one or more intranets 12 assigned to the monitoring server 11.

Each monitoring server 11 is connected to an intranet (not shown) of a vender of image forming apparatuses 15, and acquires information such as printer engine type, image formation speeds, sheet transfer paths, etc. of each image forming apparatus from a personal computer (not shown) in the vender's intranet. Based on the acquired information, the monitoring server 11 creates items (sheet transfer paths, engine speeds) of jam occurrence rate tables T2 described later with reference to FIG. 5.

Each monitoring server 11 and corresponding intranets 12 are connected via a router (not shown) to the Internet 13. Each image forming apparatus 15 in each intranet 12 is implemented by a digital MFP having functions of printer, facsimile, copier, etc. (hereinafter referred to as MFP), or by a printer, a scanner, a facsimile machine, or the like.

In this embodiment, it is assumed that MFPs are employed as the image forming apparatuses 15. These MFPs 15 are the same in mechanical construction, but some MFPs are different from the others in basic image formation speed (engine speed).

Each MFP 15 has management software. In accordance with the management software, the MFP 15 periodically transmits to the monitoring server 11 information on its operation mode, information on a parts management table T1 (described later), and operation information such as operation logs. In the periodical transmission, failure information such as service call, jam (conveyance failure), and alarm are also transmitted.

The monitoring server 11 transmits information on a jam occurrence rate table T2 (described later) to each MFP 15. For communication between the MFPs 15 and the monitoring server 11, a protocol such as SMTP (simple mail transfer protocol) is used.

FIG. 2 shows in section view the hardware configuration of the MFPs 15. As shown in FIG. 2, each MFP 15 includes an apparatus body 100 serving as a printer engine that carries out a printing process, a scanner 102 that reads document information, and an automatic document feeder (ADF) 150. The apparatus body 100 is coupled to a Z-folding apparatus 165, a bookbinding apparatus 166, and a sheet discharging apparatus 160, which are optional sheet post-processing apparatuses.

The automatic document feeder 150 sequentially picks up documents in a document setting device 150a by document pickup rollers 151 one by one from the last page and feeds each document onto an platen glass 101. After each document is read by the scanner 102, the automatic document feeder 150 discharges the document from the platen glass 101 toward a discharge tray 150b.

In a case that images of the both sides of each document are read, the document whose image on one side has been read is not immediately discharged toward the discharge tray 150b, but is inverted from front to back by a document inversion roller 152 and fed again onto the platen glass 101.

The scanner 102 is mounted with a document illuminating lamp 103 and a scanning mirror 104 which are integrally reciprocated in the left-to-right direction in FIG. 2. During the reciprocation, an image of the document is optically read. Specifically, light is irradiated onto the document from the document illuminating lamp 103, and reflection light (image light) is supplied via the scanning mirror 104, reflection mirrors 105, 106, and a lens 107 onto an image sensor 108 on which an image is formed. The image sensor 108 photoelectrically converts the incoming image light into an electrical image signal, which is output to a control unit 180, described below.

The control unit 180 performs predetermined image processing on the image signal and outputs the processed signal to a printer controller 197 (see FIG. 3), which has an exposure controller 109 shown in FIG. 1. The exposure controller 109 controls a laser device and a polygon mirror (none of which are shown), whereby a photosensitive drum 111 is exposure-scanned by a laser beam 119 modulated according to the image signal.

Around the photosensitive drum 111, there are disposed a primary charger 112, a developer 113, a transfer charger 116, a pre-exposure lamp 114, and a cleaning device 115. The photosensitive drum 111 is rotated by a motor, not shown, in the direction of an arrow in FIG. 2, is charged by the primary charger 112 to a desired electrical potential, and is then exposure-scanned by the laser beam 119 from the exposure controller 109.

With the exposure scanning, an electrostatic latent image is formed on a surface of the photosensitive drum 111. The electrostatic latent image formed on the drum 111 is visualized (developed) as a toner image by the developer 113.

Sheets are each picked up from a right sheet feed cassette 121, a left sheet feed cassette 122, an upper sheet cassette 123, or a lower sheet cassette 124 by means of a corresponding one of pickup rollers 125 to 128. Regions of conveyance paths (also called sheet transfer paths) in which the pickup rollers 125 to 128 and separation rollers 129 to 132 are disposed are called sheet feed paths.

Each picked-up (fed) sheet is conveyed by corresponding ones of the separation rollers 129 to 132, the conveyance rollers 201, 202, and a registration rollers 133 toward a transfer belt 134. In FIG. 2, each conveyance roller pair is indicated by a pair of small circles, and only two pairs of conveyance rollers are denoted by reference numerals 201, 202 for simplicity of illustration. Regions of conveyance paths in which the separation rollers 129 to 132, the conveyance rollers 201, 202, and the registration roller 133 are disposed are called feed paths.

During the sheet conveyance, the toner image on the photosensitive drum 111 is transferred by the transfer charger 116 onto the sheet. Toners remaining on the photosensitive drum 111 after the toner image transfer are cleaned by the cleaner device 115, and residual charges on the photosensitive drum 111 are erased by the pre-exposure lamp 114. Sheets can be fed from a multiple manual feed tray 155.

The sheet onto which the toner image has been transferred is separated by a separation charger 117 from the photosensitive drum 111 and conveyed by the transfer belt 134 toward a fixing device 135 that fixes the toner image on the sheet by pressure and heat. The sheet subjected to the fixing process is usually discharged by discharge rollers 136, 144 to the outside of the MFP 15 via a discharge path 143, with a print surface thereof directed upward.

When a sheet is discharged to the outside of the apparatus with its print surface directed downward or is subjected to double-sided printing, the sheet is discharged by the discharge rollers 136 and then guided toward the conveyance path 138 by a path changeover operation by a sheet discharge flapper 137.

More specifically, when the sheet subjected to single-sided printing is discharged to the outside of the apparatus with its print surface directed downward, the sheet discharge flapper 137 is moved upward and then the sheet is drawn in by inversion rollers 145 such that a rear end of the sheet is on the sheet transfer path 138 and a front end thereof is at an inlet of an inversion path 139. Then, the inversion rollers 145 are rotated reversely, whereby the sheet is conveyed toward discharge rollers 144, with the sheet reversed from front to back.

At the time of double-sided printing, the sheet discharge flapper 137 is moved upward and the sheet is guided by the inversion rollers 145 toward a refeed path 141 via the sheet transfer path 138, the inversion path 139, and a lower conveyance path 140. In that case, the sheet is drawn into the inversion path 139 to such an extent that its rear end is drawn out from the conveyance path 138 and its front part is held between the inversion rollers 145.

Subsequently, the inversion rollers 145 are rotated reversely, whereby the sheet is conveyed toward the lower conveyance path 140 and the refeed path 141. The sheet conveyed to the refeed path 141 is conveyed by refeed rollers 142 toward the registration rollers 133. The sheet conveyed to the registration rollers 133 is reversed from front to back, with its surface on which single-sided printing has been made directed downward.

It should be noted that a sheet picked up from the left feed cassette 122 by the pickup roller 126 can also be fed to the refeed path 141 via separation rollers 130.

The sheet discharging apparatus 160 has a function of aligning and binding together a plurality of sheets discharged from the apparatus body 100 of the MFP 15. Specifically, the sheet discharging apparatus 160 sequentially stacks the sheets, which are discharged one by one, on a processing tray 164. Upon completion of the image formation process (print process) for one copy set, the sheet discharging apparatus 160 staples a sheet bundle of one copy set and discharges the stapled sheet bundle onto the sheet discharge tray 162 or 163.

The sheet discharge tray 163 is vertically movable by a motor, not shown. Before start of the image formation operation, the sheet discharge tray 163 is moved to a position of the processing tray 164. Sheet bundles from the processing tray 164 are stacked on the sheet discharge tray 163. At that time, the sheet discharge tray 163 is controlled to move downward such that the uppermost surface of the stacked sheet bundles is aligned in height with the position of the processing tray 164.

An amount of downward movement of the sheet discharge tray 163 is restricted by the action of a tray lower limit sensor 168. Specifically, the tray lower limit sensor 168 is designed to be turned on when about two thousands of sheets are stacked onto the sheet discharge tray 163, whereby a further downward movement of and the resultant damage to the tray 163 can be prevented.

The sheet tray 161 is utilized to stack separation sheets each of which is inserted between sheets sequentially discharged onto the processing tray 164. The Z folding apparatus 165 performs Z-hold processing to Z-hold sheets discharged from the apparatus body 100.

The bookbinding apparatus 166 performs bookbinding by center-folding and stapling each sheet bundle of one copy set discharged from the apparatus body 100. The book-bound sheet bundle is discharged to the discharge tray 167.

Various sensors, not shown, are disposed at various places in the MFP 15 to detect various failures such as lack of toner, document jam, remaining amount of sheets, sheet jam, and document illumination lamp burnout. As described later, in this embodiment, it is also possible to manage consumption degrees of consumable parts such as the fixing device 135 and various rollers including the pickup rollers 125 to 128, the separation rollers 129 to 132, and the conveyance rollers 201, 202.

It should be noted that the separation rollers 129 to 132 are designed, for example, that a pair of rollers are rotatably driven at different relative speeds or one of the rollers is formed by a member with high friction coefficient. As a result, even when a plurality of sheets are simultaneously picked up by the pickup rollers 125 to 128, the sheets are separated one by one before being fed. Furthermore, the pickup rollers 125 to 128, the separation rollers 129 to 132, the conveyance rollers 201, 202 and other rollers are designed for ease of replacement by a general user.

Next, with reference to a block diagram of FIG. 3, the construction of the control unit 180 of the MFP 15 is described. Components of the control unit 180 are connected to a system bus 181 or an image bus 182.

A ROM 183 stores a control program for the MFP 15, which is executed by a CPU 186. The control program includes programs which are combinations of commands relating to the below-mentioned processes shown in FIGS. 6 to 9. A RAM 184 is utilized as a work memory area for execution of the programs and an image memory for temporary storage of image data, etc.

An accumulation memory 185 is a nonvolatile memory storing various data, etc., which are to be kept stored even after electric power of the MFP 15 is turned off. Specifically, the accumulation memory 185 stores a parts management table T1 and a priority determination table T3, which are described later with reference to FIGS. 4 and 10. The accumulation memory 185 also stores operation logs, service call error, jam error, alarm warning, and other failure information.

An operation unit 188 has various function keys, numeric keys, and a display unit, not shown. By operating these keys, an operator is able to give various setting instructions, operation start/stop instructions, etc. relating to scanner reading and print output.

Each of key operation signals is input to the CPU 186, which carries out processing corresponding to the key operation and causes a display unit of the operating unit 188 to display, e.g., information described later with reference to FIGS. 11 and 12.

A network I/F 189 is an interface for connection with the LAN 14 in FIG. 1, and performs communication with the monitoring server 11 via the LAN 14. A line I/F unit 190 is connected to an ISDN or a public telephone line for data transmission and reception with a remote terminal such as a facsimile machine.

An IO control unit 187 functions as a bus bridge for connecting the system bus 181 with the image bus 182. The above described devices 183 to 190 are connected to the system bus 181. The image bus 182 is a bus for transferring image data at high speed and implemented by a PCI bus or IEEE 1394. The following devices are connected to the image bus 182.

A digital I/F device 193 connects the reader controller 196 and the printer controller 197 of the MFP 15 with the control unit 180 and performs synchronous/asynchronous conversion of image data. Detection signals from various sensors, not shown, disposed at various places in the MFP 15 are delivered via the digital I/F device 193 to the CPU 186 of the control unit 180.

The reader controller 196 drivingly controls the scanner 102 in FIG. 1. The printer controller 197 controls the exposure controller 109 in FIG. 1 and drivingly controls the printer engine including the photosensitive drum 111, etc.

An image processing unit 191 performs correction, modification, and editing on input and output image data. An image rotation unit 192 performs rotation processing on image data. An image compression/decompression unit 194 performs JPEG compression/decompression processing on multi-valued image data and JBIG, MMR, MR, or MH compression/decompression processing on binary image data. A pixel density conversion unit 195 performs resolution conversion or image density conversion processing on output image data.

A parts management table T1 shown in FIG. 4 is stored in the accumulation memory 185 of each MFP 15. In the table T1, there are registered information on model of the printer engine of the MFP 15 mounted with the accumulation memory 185, ID information on the MFP, information on engine speed of the printer engine, information on sheet size, sheet type of each feed cassette, etc.

As for the engine speed of the printer engine of the MFP 15, if the printer engine is operable at plural engine speeds, e.g., 30 ppm and 25 ppm (pages per minute), these engine speeds are registered in the table T1.

In the parts management table T1, a parts code, a current counter value, prescribed service life, consumption degree, jam rate (jam occurrence rate) per hundred sheets are registered for each of conveyance parts, which are consumable parts. It is assumed here that consumable parts include the fixing device 135 and rollers such as the pickup rollers 125 to 128, separation rollers 129 to 132, and conveyance rollers 201, 202. For example, a parts code of “10000001” in FIG. 4 represents the pickup roller 125.

The “current counter value” represents the number of times processing has been made by the consumable part associated therewith. Referring to FIG. 4, it is indicated, for example, that the pickup roller 125 represented by the parts code of 10000001 has performed a sheet-pickup operation 248972 times up to the present time. The count processing is performed by the CPU 186, and the “current counter value” obtained by the count processing is utilized as information based on which it is determined whether or not a job set by a user should be performed as it is. The “prescribed service life” represents a limit value of the number of times (service life value) processing can be made by use of the consumable part. The “consumption degree” represents a ratio (percentage) of the “current counter value” to the “prescribed service life” of the consumable part.

The “jam occurrence rate per hundred sheets” represents an occurrence rate of sheet jam observed when a hundred of sheets are processed by the consumable part. In a case that the printer engine is of a type having plural engine speeds, the “jam occurrence rate per hundred sheets” is registered for each engine speed.

The current counter value, prescribed service life, consumption degree, and jam occurrence rate per hundred sheets for each consumable part in the parts management table T1 are updated by the CPU 186 of the control unit 180 of each MFP 15 each time the consumable part is used. It should be noted that identification information such as path names of sheet transfer paths having consumable parts disposed therein can be registered in the parts management table T1 to correspond to the consumable parts identified by parts codes. Data registered in the parts management table T1 is periodically transmitted by the CPU 186 to the monitoring server 11.

The monitoring server 11 holds jam occurrence rate tables (one of which is shown at T2 in FIG. 5) each of which is created for a corresponding one of printer engine types. In each table T2, a type name of printer engine (X307 in FIG. 5) and a statistical parameter for the printer engine type are registered.

As actual jam occurrence rate data, a jam occurrence rate (failure occurrence rate) is registered for each engine speed of printer engine types and for each sheet transfer path (conveyance path). Sheet transfer paths vary according to a combination of sheet feed cassettes for housing sheets and optional apparatuses such as a finisher. Thus, all the MFPs 15 do not necessarily have the same sheet transfer paths.

In this embodiment, sheet transfer paths are set to encompass all the combinations of optional apparatuses in order to handle any cases where the optional apparatuses are used in various combinations. To this end, a sheet transfer path ID is assigned to each of the sheet transfer paths set in advance by taking all the combinations of optional apparatuses into consideration, and sheet transfer path IDs are registered in the jam occurrence rate table T2.

In that case, each sheet transfer path ID uniquely corresponds to one of the parts codes. A relation of correspondence between sheet transfer path IDs and parts codes is notified from the monitoring server 11 to each of MFPs 15 mounted with the printer engine of the type concerned.

A jam occurrence rate for each combination of engine speed and sheet transfer path is calculated as follows: In an example where consumable parts A1, A2 are disposed in path A, jam occurrence rates per hundred sheets for consumable parts A1, A2 in FIG. 4 at a given engine speed are added together, and the sum of the jam occurrence rates is divided by the number of parts (two in this example) to obtain an average value of the jam occurrence rates.

Then, average jam occurrence rates, which correspond in number to the statistical parameter for the same printer engine type, at the given engine speed are added together, and the sum of the average jam occurrence rates are divided by the statistical parameter, thereby obtaining an average jam occurrence rate for these printer engines at that engine speed. The statistical average value at the engine speed is used as the jam occurrence rate in the path A at that engine speed.

In the calculation of the jam occurrence rate for each sheet transfer path, the jam occurrence rate may be modified by weights determined by taking circumstances for the printer engine type into consideration. For example, the jam occurrence rate for each sheet transfer path may be calculated not only based on actually measured jam occurrence rates but also using weights determined by taking into consideration the consumption degrees of associated consumable parts indicated in the parts management table T1, environmental values such as installation places of MFPs 15, humidity, and temperature, sheet type, etc.

Data registered in the parts management table T1 in FIG. 4 and the jam occurrence rate table T2 in FIG. 5 are notified between each MFP 15 and the monitoring server 11 as shown in FIG. 6. Specifically, the monitoring server 11 acquires from each MFP 15 conveyance failure occurrence information on each sheet transfer path of the MFP 15 and transmits statistical conveyance failure occurrence information to the MFP 15.

In this embodiment, each MFP 15 voluntarily and periodically transmits the registration data in the parts management table T1, and in response thereto, the monitoring server 11 sends back to the MFP 15 the registration data in the jam occurrence rate table T2 associated with the type of the printer engine mounted on the MFP 15.

Alternatively, the monitoring server 11 may periodically transmit to each MFP 15 the registration data in the jam occurrence rate table T2 associated with the type of the printer engine mounted on the MFP 15, and in response thereto, each MFP 15 may send back the registration data in the parts management table T1.

In the following, the outline of a job process executed in each MFP 15 is described with reference to a flowchart of FIG. 7. It is assumed here that a job in the job process is to perform scanner processing to read an image, print processing to perform printing, copy processing to perform both the scanner processing and the print processing, or processing to perform post-processing such as bookbinding in addition to the scanner processing and the print processing.

When a request for start of a job set by a user is received from the operation unit 188 operated by the user (step S701), the CPU 186 of the control unit 180 of each MFP 15 determines whether or not there is any consumable part whose consumption degree is equal to or larger than a threshold value, among consumption degrees of all the consumable parts registered in the parts management table T1 (step S702).

If it is determined in step S702 that there is no consumable part whose consumption degree is not less than the threshold value, the CPU 186 executes the job as usual (step S706). Then, according to a status of execution of the job, the CPU 186 updates the registration data in the parts management table T1 (step S707).

On the other hand, if it is determined in step S702 that there is a consumable part whose consumption degree is equal to or larger than the threshold value, the CPU 186 selects, based on the jam occurrence rate table T2, candidates for alternative sheet transfer path (alternative job) appropriate for execution of the job set by the user (step S703), and displays the candidates for alternative sheet transfer path (step S704).

In the processing to select the candidates for alternative sheet transfer path, the candidates can be selected in the ascending order of jam occurrence rate in a range where a reduction in print speed can be minimized. The details of the processing in steps S703 and S704 will be described later.

Next, in accordance with a user's operation performed in response to the candidates being displayed in step S704, the CPU 186 selects an appropriate engine speed (step S705). In the processing to select the engine speed, the highest engine speed is selected among engine speeds at which the jam occurrence rate is equal to or less than a given rate, as described later.

Then, the CPU 186 executes the job in step S706 and updates the registration data in the parts management table T1 in step S707. In step S706, the job is executed in accordance with the user's response to the candidates for alternative path being displayed in step S704 or the engine speed selected in step S705.

Next, with reference to a flowchart of FIG. 8, the details of the job process performed by each MFP 15 are described.

When the user operates the operation unit 188 of the MFP 15 to set a job and gives an instruction to start the job, the CPU 186 of the MFP 15 checks for current counter values (consumption degrees) of all the rollers in the MFP 15 including optional apparatuses currently connected thereto (step S801). The checking of consumption degrees is made referring to the parts management table T1 in FIG. 4.

Next, the CPU 186 determines whether or not the consumption degrees of all the rollers are equal to or less than a prescribed value (step S802). If the consumption degrees of all the rollers are equal to or less than the prescribed value, there is a low possibility of jam occurrence even when the job is carried out as set by the user, and therefore the CPU 186 executes an ordinary job process in which the job is executed as set by the user (step S803).

It should be noted that the print speed is, of course, not changed in the ordinary job process in step S803. The print speed is not changed also when the process proceeds from the below-described step S806 or S812 to step S803.

On the other hand, if at least one of the rollers of the MFP 15 has a consumption degree exceeding the prescribed value, the CPU 186 selects all the sheet transfer paths (conveyance paths) used for the job (step S804). These sheet transfer paths include the sheet feed path, feed path, inversion path, discharge path, etc.

Next, the CPU 186 acquires jam occurrence rates in all the sheet transfer paths used for the job from the jam occurrence rate table T2 in FIG. 5 (step S805). Then, the CPU 186 determines whether or not jam occurrence rates in all the sheet transfer paths used for the job are equal to or less than an upper limit value (for example, 1%) (step S806).

In a case that jam occurrence rates in all the sheet transfer paths are equal to or less than the upper limit value, there is a low possibility of jam occurrence even when the job is carried out as set by the user. Thus, the CPU 186 proceeds to step S803 and executes the ordinary job process in which the job is carried out as set by the user.

On the other hand, if at least one of sheet transfer paths used for the job has a jam occurrence rate exceeding the upper limit value, there is a high possibility of jam occurrence if the job is performed as set by the user. Thus, the CPU 186 performs a candidate alternative path selection process to select candidates for alternative path (alternative job) for the sheet transfer path having a jam occurrence rate exceeding the upper limit (step S807). In the selection process, weights are assigned to the selected candidate alternative paths such that a larger weight is assigned to a candidate for alternative path which is lower in jam occurrence rate.

Next, the CPU 186 performs a first weighing process in which weights are assigned to the selected candidates for alternative sheet transfer path such that a larger weight is assigned to a candidate alternative job that can be performed without changing a sheet feed cassette from that in the job set by the user (step S808). Next, the CPU 186 performs a second weighting process in which weights are assigned to the candidates for alternative sheet transfer path such that a larger weight is assigned to a candidate alternative job that can be performed without changing the setting of double-sided printing, sheet discharging with back surface facing up, or the like from that in the job setting specified by the user (step S809).

Further, the CPU 186 performs a third weighting process in which weights are assigned to the alternative sheet transfer path candidates such that a larger weight is assigned to a candidate alternative job that can be performed without changing sheet post-processing such as stapling and sheet discharge tray setting from those in the job setting specified by the user (step S810). The details of the weighting processes will be described later.

Next, the CPU 186 selects from the candidates for alternative sheet transfer path a predetermined number of candidates which are large in the sum of weight values and displays options on a display screen of the operation unit 188 (step S811). The options include forcible execution of the job set by the user and the candidates for alternative job (alterations to the settings required when the selected candidates for alternative sheet transfer path are used).

As shown in FIGS. 11 and 12, there are displayed on the display screen a name of a roller for which it has been determined in step S802 that the consumption degree thereof exceeds the prescribed value, guidance information stating that the roller should be replaced, a “CANCEL” button, and an “OK” button.

As for the alterations to the settings required when the candidates for alternative sheet transfer path are used, the user generally does not know names or positions of sheet transfer paths, and therefore does not know what to do if the names or positions of candidates for sheet transfer path are displayed. In this embodiment, instead of displaying the names or positions of candidates for alternative sheet transfer path, there are displayed setting alteration buttons to prevent any conveyance roller from being used whose consumption degree exceeds the prescribed value, thereby improving the user's convenience.

It should be noted that as the setting alteration buttons there are a “double-sided to manual double-sided” button 1102 and a “double-sided to single-sided” button 1103 shown in FIG. 11 and a “second-cassette selection” button 1201, a “manual-cassette selection” button 1202, and a “first-cassette selection” button 1203 shown in FIG. 12. Reference numerals 1101, 1204 in FIGS. 11, 12 each denote a “forcible execution (low speed)” button.

It should be noted that CANCEL buttons 1104, 1205 in FIGS. 11, 12 are for canceling the selection of setting alteration or canceling the job itself, etc. OK buttons 1104, 1206 in FIGS. 11 and 12 are for confirming the setting alteration or confirming the selection of forcible execution.

Next, the CPU 186 determines whether or not any of the setting alteration buttons is depressed by the user (step S812). If it is determined that any of the setting alteration buttons is depressed, the CPU 186 executes the job set by the user while using the alternative sheet transfer path associated with the depressed button (step S803). In that case, the “forcible execution (low speed)” button 1101 is not depressed and therefore the print speed never be changed.

On the other hand, if the setting alteration is not selected but the forcible execution is set and confirmed, the CPU 186 executes the job while lowering the print speed (step S813). The term “print speed” not only includes narrowly-defined engine speeds, i.e., the speed of image formation on the photosensitive drum and sheet feed speed (rotation speeds of drive motors for the photosensitive drum, various rollers, etc.), but also includes the print speed changed according to the distance between sheets as viewed in the sheet conveyance direction.

In the following, the details of the low-speed job process in step S813 are described with reference to a flowchart of FIG. 9.

The CPU 186 determines whether or not the engine speed of the MFP 15 can be changed (step S901). If it is determined that the engine speed can be changed, the CPU 186 decides based on the jam occurrence rate table T2 the engine speed for execution of the job set by the user (step S902).

As for a sheet transfer path used for the job and including a roller whose consumption degree exceeds the prescribed value, the CPU 186 selects the fastest engine speed at which the jam occurrence rate does not exceed the upper limit value and which is within a range where the engine speed is slower than that set in the job setting. In this embodiment, the upper limit vale is set to 1%.

It is assumed, for example, that the consumption degree of a roller disposed in the sheet transfer path A in FIG. 5 exceeds the prescribed value and the engine speed is currently set to 30 ppm. In the jam occurrence rate table T2 in FIG. 5, the jam occurrence rates in the path A at engine speeds of 30 ppm, 25 ppm, and 15 ppm are 5.10%, 2.10%, and 0.02%, respectively.

In the path A, the jam occurrence rate at engine speed of 15 ppm is equal to or less than the upper limit value of 1%, but the jam occurrence rates at engine speeds of 30 ppm and 25 ppm exceed the upper limit value of 1%.

In this case, the CPU 186 selects the engine speed of 15 ppm in step S902. It should be noted that with respect to a sheet transfer path used for the job set by the user and including a roller whose consumption degree exceeds the prescribed value, if jam occurrence rates at all the engine speeds exceed the upper limit value, the lowest engine speed is selected.

Next, the CPU 186 changes the sheet feed speed according to the engine speed selected in step S902 (step S903). The term “sheet feed speed” indicates a conveyance speed of sheet after being picked up from a cassette deck or the like, i.e., a conveyance speed varying depending on roller rotation speed, but does not indicate a sheet feed speed that varies according to the distance between sheets.

Next, the CPU 186 executes the job set by the user at the engine speed selected in step S902 (step S904). In most cases, the engine speed selected in step S902 is lower than the ordinary engine speed and rollers are driven to rotate at low speeds. Therefore, even if there is a consumed roller in the sheet transfer path, the stability in sheet conveyance is improved and jam occurrence is suppressed to a minimum since sheets are conveyed by rollers rotated at low speeds.

On the other hand, if the engine speed cannot be changed, the CPU 186 determines whether or not the jam occurrence rate in the sheet feed path including the pickup rollers 125 to 128 exceeds the upper limit value (step S905). This determination is performed based on the result of determination in step S806 in FIG. 8 (ditto in step S907). If it is determined that the jam occurrence rate in the sheet feed path does not exceed the upper limit value, the CPU 186 proceeds to step S907.

On the other hand, if the jam occurrence rate in the sheet feed path exceeds the upper limit value, the CPU 186 increases the upper limit value of the number of times of retry of sheet pickup by the pickup rollers 125 to 128 (step S906) and proceeds to step S907. By increasing the upper limit value of the number of times of retry in this manner, the probability that occurrence of failure or jam is determined becomes low, even if the sheet pickup is retried.

In step S907, the CPU 186 determines whether or not the jam occurrence rate either in the conveyance path or the sheet discharge path exceeds the upper limit value. If it is determined that the jam occurrence rates in the conveyance path and the sheet discharge path do not exceed the upper limit value, the CPU 186 proceeds to step S909.

On the other hand, if the jam occurrence rate in the conveyance path or the sheet discharge path exceeds the upper limit value, the CPU 186 increases a margin of jam determination time based on sheet detection signals from jam detection sensors, not shown (step S908) and proceeds to step S909. The processing in step S908 decreases the probability of jam occurrence being determined.

In step S909, the CPU 186 changes sheet feed timing so as to increase the distance between fed sheets. To change the sheet feed timing, it is enough, for example, to increase intervals at which sheets are picked up by the pickup rollers 125 to 128.

In this embodiment, to simplify the control, the distance between sheets is set in step S909 without exception such that the print speed becomes equal to the lowest print speed of 15 ppm, but this is not limitative. For example, the distance between sheets may be increased to obtain the fastest print speed in a range in which effect to suppress jam occurrence can be attained, while taking account of the type of MFP 15, the sheet transfer path including a roller whose consumption degree exceeds the prescribed value, and the like.

Next, the CPU 186 carries out the job set by the user at a low printing speed at which the distance between sheets becomes large (step S910). In this manner, the printing is performed practically at a low speed to thereby decrease the probability of jam occurrence being determined, even if the engine speed cannot be changed.

In the following, the details of the processing in steps S807 to S811 in FIG. 8, especially, weighing processes, are described based on a priority determination table T3 in FIG. 10. In the priority determination table T3, there are registered weight values (weight information) that are assigned to conveyance paths (sheet transfer paths) so as to correspond to sheet conveyance parts disposed in these conveyance paths, which are the document pickup rollers 151, document inversion roller 152, pickup rollers 125 to 128, separation rollers 129 to 132, etc.

Specifically, numerical values such as 0, 0.5, and 1 in the priority determination table T3 of FIG. 10 are weight values that determine priorities with which candidates for alternative path (alternative job) are selected. The weight values vary from a minimum value of 0 to a maximum value of 1. A larger weight value indicates a higher priority. A weight value of 0.5 is a limit value only above which a print output can be obtained in the form desired by the user. At a weight value equal to or less than 0.4, a print output cannot be obtained in the form desired by the user. A weight value for execution of low-speed job is equal to 0.4 without exception.

It is assumed, for example, that a job to perform double-sided reading is set in a condition that the consumption degree of document pickup rollers 151 of the automatic document feeder (ADF) 150 exceeds a prescribed value. In that case, if the job is executed as it is, there is a high possibility of jam occurrence and there is a fear that the executed job is wasted.

Therefore, in such a case, based on the priority determination table T3 of FIG. 10, the CPU 186 assigns a weight of 0.5 (limit value) to a sheet transfer path which is used for pressing plate/double-sided reading and which is a candidate for alternative path in which the document pickup rollers 151 are not used whose consumption degree exceeds the prescribed value.

On the other hand, the CPU 186 assigns a weight of 0 (lowest priority) to two other sheet transfer paths not relating to the job setting (double-sided reading) among sheet transfer paths associated with the document pickup rollers 151. In that case, a pressing plate/double-sided reading job assigned with a higher priority and a low-speed job assigned with a lower priority are displayed as candidates for alternative job in step S811 of FIG. 8.

Next, it is assumed that a job to perform mixed document reading is set in a condition that the consumption degree of the document pickup rollers 151 exceeds the prescribed value. In that case, the document pickup rollers 151 are required to sequentially feed documents of different sizes set in the document setting device 150a, and therefore there is a higher possibility of jam occurrence than in the above example.

In this case, the CPU 186 assigns a weight of 0.3, providing a lower priority than that provided by the weight of 0.5 in the above example, to a sheet transfer path which is used for the pressing plate reading/mixed-document reading and which is a candidate for alternative path in which the document pickup rollers 151 are not used whose consumption degree exceeds the prescribed value.

On the other hand, the CPU 186 assigns a weight of 0 (lowest priority) to two other sheet transfer paths not relating to the job setting (mixed reading) among sheet transfer paths relating to the document pickup rollers 151. In that case, a low-speed job assigned with a higher priority and a pressing plate reading assigned with a lower priority are displayed as candidates for alternative job in step S811 of FIG. 8.

Next, it is assumed that a job to perform elongated or non-standard sized document reading is set in a condition that the consumption degree of the document pickup rollers 151 exceeds the prescribed value. In that case, the document pickup rollers 151 are required to sequentially feed elongated or non-standard sized documents set in the document setting device 150a and therefore, there is a higher possibility of jam occurrence than in the second example described above.

In such a case, the CPU 186 assigns a weight of 0.1, providing a lower priority than that provided by the weight of 0.3 in the above example, to a sheet transfer path which is used for the pressuring plate reading and elongated/non-standard sized document reading and which is a candidate for alternative path in which the document pickup rollers 151 are not used whose consumption degree exceeds the prescribed value.

On the other hand, the CPU 186 assigns a weight of 0 (lowest priority) to two other sheet transfer paths not relating to the job setting (elongated/non-standard sized document reading) among sheet transfer paths in which the document pickup rollers 151 are used. In that case, a low-speed job assigned with a higher priority and a pressurizing plate reading job assigned with a lower priority are displayed as candidates for alternative job in step S811 of FIG. 8.

Next, it is assumed that a job to perform double-sided reading is set in a condition that the consumption degree of the document inversion roller 152 of the automatic document feeder (ADF) 150 exceeds the prescribed value. In that case, if the job is executed as it is, there is a high possibility of jam occurrence and there is a fear that the executed job is wasted.

In such a case, based on the priority determination table T3 of FIG. 10, the CPU 186 assigns a weight of 0.5 (limit value) to a sheet transfer path which is used for pressuring plate/double-sided reading and which is a candidate for alternative path in which the document inversion roller 152 is not used whose consumption degree exceeds the prescribed value.

On the other hand, the CPU 186 assigns a weight of 0 (lowest priority) to two other sheet transfer paths not relating to the job setting (double-sided reading) among sheet transfer paths in which the document inversion roller 152 is used. In that case, a pressurizing plate reading job assigned with a higher priority, a low-speed job assigned with a next higher priority, and a single-sided reading job assigned with a lower priority are displayed as candidates for alternative job in step S811 of FIG. 8.

Next, it is assumed that a job to perform single-sided reading (mixed-document reading or elongated/non-standard sized document reading may simultaneously be performed) is set in a condition that the consumption degree of the document inversion roller 152 of the automatic document feeder (ADF) 150 exceeds the prescribed value.

In that case, the document inversion roller 152 is not used in the job. Thus, even if the job is executed as it is, there is no possibility of jam occurrence at the document inversion roller 152. The CPU 186 therefore executes the job set by the user as it is as long as other roller has no trouble.

Next, it is assumed that in a condition that the consumption degree of any of the pickup rollers 125 to 129 and the separation rollers 129 to 132 of the apparatus body (printer engine) 100 exceeds the prescribed value, a job is set in which any of the upper, lower, left and right cassettes 121 to 124 is specified that corresponds to the roller whose consumption degree exceeds the prescribed value. In that case, if the job is executed as it is, there is a high possibility of jam occurrence and there is a fear that the executed job is wasted.

In that case, the CPU 186 assigns a weight of 0.9 to a sheet transfer path corresponding to other cassette which is the same in size and media type as the specified cassette. The term “media type” represents a type of sheet such as standard paper, heavy paper, colored paper, bond paper, or OHP paper.

The CPU 186 assigns a weight of 0.3 (low priority) to a sheet transfer path corresponding to other cassette which is the same in size as the specified cassette but different in media type therefrom, and assigns a weight of 0.2 (lower priority) to a sheet transfer path corresponding to other cassette which is different in size from the specified cassette.

In that case, a job specifying the sheet feeding from a cassette which is the same in media type as the specified cassette and assigned with a higher priority, a low-speed job assigned with a next higher priority, and a job specifying the sheet feeding from a cassette which is different in media type from the specified cassette and assigned with a lower priority are displayed as candidates for alternative job in step S811 of FIG. 8.

Next, it is assumed that a job setting is made in which document mixing and automatic cassette selection are specified, there is a possibility that sheets are fed not only from the cassettes 121 to 124 but also from the multiple manual feed tray 155. Thus, the CPU 186 assigns a weight of 0.3 to each of sheet transfer paths relating to the cassettes 121 to 124 and the manual feed tray 155.

In that case, a low-speed job assigned with a higher priority and a job specifying a cassette selection and assigned with a lower priority are displayed as candidates for alternative job in step S811 of FIG. 8.

Next, it is assumed that a job specifying an output size and a cassette in which sheets of the specified output size are not housed is set. In that case, sheets of the specified output size cannot be fed from the specified cassette. The CPU 186 assigns a weight of 1 to a sheet transfer path relating to a cassette other than the specified cassette, if any, in which sheets of the specified output size are housed, and assigns a weight of 0.3 or 0.2 to a sheet transfer path relating to other cassette than the just-mentioned cassette.

In this case, a low-speed job assigned with a higher priority and a job specifying a cassette selection and assigned with a lower priority are displayed as candidates for alternative job in step S811 of FIG. 8.

Next, it is assumed that a job specifying double-sided printing and bookbinding output is set in a condition that the consumption degree of any of the inversion roller 145 and conveyance rollers in the lower conveyance path 140 and the refeed path 141 of the printer engine exceeds the prescribed value. In that case, sheets cannot be conveyed in a reversed state, if the job is executed as it is.

Thus, the CPU 186 assigns a weight of 0.4 to a sheet transfer path relating to double-sided printing by manual feed, assigns a weight of 0.1 to a sheet transfer path relating to single-side printing by manual feed, and assigns a weight of 0 to other sheet transfer paths. In this case, a double-sided printing job by manual feed and a low-speed job which are assigned with the same higher priority and a single-sided printing job assigned with a lower priority are displayed as candidates for alternative job in step S811 of FIG. 8.

Next, it is assumed that in a condition, for example, that the consumption degree of any of consumable parts in the sheet discharge paths 170 to 172 and the bookbinding path 173 exceeds the prescribed value, a job using such path is set. In that case, sheets cannot be discharged to a specified sheet discharge tray, if the job is executed as it is.

Thus, the CPU 186 assigns a weight of 0.6 to a sheet discharge tray which is not specified in the job setting, i.e., for which a finishing setting is not specified, and assigns a weight of 0.5 to a sheet discharge tray for which a finishing setting is specified. In this case, a job specifying a finishing output stage (sheet discharge tray) and assigned with a higher priority and a low-speed job assigned with a lower priority are displayed as candidates for alternative job in step S811 of FIG. 8.

It should be noted that the term “finishing setting” represents an output setting such as stapling, punching, trimming, bookbinding, Z-folding, or the like. In a case that consumption degrees of plural consumable parts, among consumable parts relating to the finishing setting, exceed the prescribed value, finishing output stages are sequentially selected by the user in the order from an upstream-side finishing output stage.

FIG. 11 shows an example of a candidate alternative job display screen (presentation screen). In this example display screen, there is indicated a consumable part in a sheet transfer path specified in a double-sided output setting. An inversion roller displayed in this example screen corresponds to the inversion roller 145 in FIG. 2.

Although a single-sided path is indicated as an alternative sheet transfer path in the priority determination table T3, a printed sheet desired by the user cannot be obtained by using the single-sided path. Thus, a statement is displayed on the candidate alternative job display screen in FIG. 11 to the effect that forcible execution (low speed) is automatically selected as a candidate for alternative job with a top priority.

FIG. 12 shows another example of candidate alternative job display screen. In this example, there is indicated a consumable part in a sheet transfer path relating to the setting in which a cassette stage is specified. A sheet feed roller displayed in this example screen corresponds to the pickup roller 128 shown in FIG. 2.

In the candidate alternative job display screen in FIG. 12, it is indicated that a sheet feed path relating to sheets which are the same in size as those for the set sheet feed path is automatically selected based on the priority determination table T3 as a candidate for alternative sheet transfer path with a top priority. The candidate alternative sheet transfer path is displayed with a top priority since printed sheets desired by the user can be obtained using that candidate alternative sheet transfer path.

It is to be understood that the present invention may also be accomplished by supplying a system or an apparatus with a storage medium in which a program code of software, which realizes the functions of the above described embodiment is stored and by causing a computer (or CPU or MPU) of the system or apparatus to read out and execute the program code stored in the storage medium.

In that case, the program code itself read from the storage medium realizes the functions of the above described embodiment, and therefore the program code and the storage medium in which the program code is stored constitute the present invention.

Examples of the storage medium for supplying the program code include a floppy (registered trademark) disk, a hard disk, and a magnetic-optical disk, an optical disk such as a CD-ROM, a CD-R, a CD-RW, a DVD-ROM, a DVD-RAM, a DVD-RW, a DVD+RW, a magnetic tape, a nonvolatile memory card, and a ROM. The program code may be downloaded via a network.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiment. The scope of the following claims is to be accorded the broadest interpretation so as to encompass all such modifications and equivalent structures and functions.

### INDUSTRIAL APPLICABILITY

According to this invention, it is possible to use an image forming apparatus over a longest possible time period without determining the necessity of part replacement, whereby convenience can be improved.

1. An image forming apparatus comprising:
a counting unit adapted to count consumption degrees of conveyance parts in a plurality of conveyance paths along which sheets are conveyed;
an acquisition unit adapted to acquire information on occurrence of conveyance failure in each of the plurality of conveyance paths;
a determination unit adapted to determine, based on a result of counting by said counting unit, whether or not the consumption degree of a conveyance part in a conveyance path, among the plurality of conveyance paths, used for execution of a job set by an operation on an operation unit exceeds a prescribed value;
a selection unit adapted, in a case where said determination unit determines that the consumption degree exceeds the prescribed value, to select a candidate for alternative process for the job based on the information on occurrence of conveyance failure acquired by said acquisition unit; and
a presentation unit adapted to present the candidate for alternative process selected by said selection unit.

2. The image forming apparatus according to claim 1, including:
a transmission unit adapted to transmit to a server apparatus the information on occurrence of conveyance failure in each of the plurality of conveyance paths.

3. The image forming apparatus according to claim 2, wherein said transmission unit periodically transmits to the server apparatus, as the information on occurrence of conveyance failure, at least model information on the image forming apparatus, the consumption degree determined by the counting by said counting unit, and a failure occurrence rate.

4. The image forming apparatus according to claim 1, wherein said acquisition unit acquires from the server apparatus the information on occurrence of conveyance failure in each of the plurality of conveyance paths.

5. The image forming apparatus according to claim 1, wherein said selection unit selects a plurality of candidates for alternative process.

6. The image forming apparatus according to claim 1, wherein said selection unit selects, as the candidate for alternative process, an alternative job in which is used a conveyance path having a part whose consumption degree does not exceed the prescribed value.

7. The image forming apparatus according to claim 6, wherein said selection unit selects the alternative process in which is used a conveyance path having a part whose consumption degree does not exceed the prescribed value, by using weighting information given to the conveyance path.

8. The image forming apparatus according to claim 1, wherein said selection unit selects, as the candidate for alternative process, an alternative process in which the sheets are conveyed at a low speed.

9. A control method for an image forming apparatus comprising:
a counting step of counting consumption degrees of conveyance parts in a plurality of conveyance paths along which sheets are conveyed;
an acquisition step of acquiring information on occurrence of conveyance failure in each of the plurality of conveyance paths;
a determination step of determining, based on a result of counting in said counting step, whether or not the consumption degree of a conveyance part in a conveyance path, among the plurality of conveyance paths, used for execution of a job set by an operation on an operation unit exceeds a prescribed value;
a selection step of selecting, in a case where said determination step determines that the consumption degree exceeds the prescribed value, a candidate for alternative process for the job based on the information on occurrence of conveyance failure acquired in said acquisition step; and
a presentation step of presenting the candidate for alternative process selected in said selection step.

10. A computer-readable storage medium storing a program for causing a computer to execute a control method for an image forming apparatus, the control method comprising:
a counting step of counting consumption degrees of conveyance parts in a plurality of conveyance paths along which sheets are conveyed;
an acquisition step of acquiring information on occurrence of conveyance failure in each of the plurality of conveyance paths;
a determination step of determining, based on a result of counting in said counting step, whether or not the consumption degree of a conveyance part in a conveyance path, among the plurality of conveyance paths, used for execution of a job set by an operation on an operation unit exceeds a prescribed value;
a selection step of selecting, in a case where said determination step determines that the consumption degree exceeds the prescribed value, a candidate for alternative process for the job based on the information on occurrence of conveyance failure acquired in said acquisition step; and
a presentation step of presenting the candidate for alternative process selected in said selection step.
